(19) United States
(12) Patent Application Publication
(10) Pub. No.: US 2003/0074233 A1
(43) Pub. Date: Apr. 17, 2003

(54) System and method for designing a life insurance program for an organization

(76) Inventor: John Ridings Lee, Dallas, TX (US)

Correspondence Address: THOMPSON & KNIGHT, L.L.P., PATENT PROSECUTION GROUP, 1700 PACIFIC AVENUE, SUITE 3300, DALLAS, TX, 75201, US

(21) Appl. No.: 10/046,005

(22) Filed: Oct. 27, 2001

Related U.S. Application Data
(60) Provisional application No. 60/322,155, filed on Sep. 14, 2001.

(51) Int. Cl. G06F 17/60

(52) U.S. Cl. 705/4

(57) ABSTRACT

A method of administering a life insurance program for an organization is provided. The administering entity obtains a list of donors who have consented to participation in the life insurance program and then constructs a participant pool of donors who will actually participate in the program. The entity constructs the participant pool according to a mortality matrix, which describes an ideal participant pool. Donors within the participant pool are selected according to the donors' ages and genders, and the number of donors in the participant pool at any particular age and gender are defined by the mortality matrix.

### CROSS-REFERENCE TO RELATED APPLICATIONS

This application claims the benefit of U.S. Provisional Application No. 60/322,155, filed Sep. 14, 2001, which is hereby incorporated by reference.

This application is filed concurrently with an application entitled “Method of Raising Funds For an Organization,” also invented by John Ridings Lee. The concurrently filed application is incorporated by reference to the maximum extent allowable by law.

### BACKGROUND OF THE INVENTION

1. Field of the Invention

This invention relates generally to a method of designing a life insurance program for an organization and in particular to a method of designing a life insurance program for an organization through which the organization receives death benefit payments from a matrix-driven life insurance pool.

2. Description of Related Art

Fund raising is important to many corporations and other organizations. Non-profit organizations in particular often benefit from the monetary donations of supporters. Charities, churches, schools, hospital foundations, and other groups are usually considered non-profit organizations, and in many legal jurisdictions these organizations receive favorable tax treatment and consideration.

Organizations that rely on fund raising have traditionally allowed supporters to donate the benefit payments from life insurance policies. The traditional method of donation required the individual donor to purchase a life insurance policy and designate the organization as the beneficiary. The individual donor was the owner of the policy. The primary problem with this method of donation was the level of commitment required by the individual donor. In order for the organization to finally collect on the donation, the individual donor would have to pay premiums on the policy up until his own death. Needless to say, many of these policies eventually lapsed, and the organization never realized any gain. Similar problems occurred if the individual donor had a “parting of ways” with the organization, or if the donor found new organizations he wished to support.

Organizations soon discovered a solution to the “donor owned” method of donating life insurance benefits. Since an organization is permitted to hold insurable interests on the lives of its donors, the organization can purchase and own life insurance policies on the lives of those donors that consent. As the owner of the policy, the organization pays the premiums, thereby controlling the policy to which it is the beneficiary. However, the attractiveness of such a plan is minimal when the life insurance policy is purchased on the life of one or only a few donors. An organization doing so is essentially gambling with the insurance company that the amount of premiums paid by the organization will be less than the amount of death benefits obtained from the policies. Such a fund-raising plan would not be seriously considered by most organizations.

The creation of foundation-owned life insurance (FOLI) eliminated some of the risks associated with an organization purchasing life insurance on the lives of its donors. Instead of purchasing a small number of policies, a group of policies is purchased on the lives of many donors who have consented to participation. Although FOLI eliminated some of the risks associated with buying only a few policies, these life insurance policies require full medical underwriting, and no attempt is made to structure the pool of donors based upon age and gender. This often haphazard method of obtaining donor pools results in a substantially low level of predictability with respect to mortality of donors. While mortality tables can somewhat predict the outcome of an established pool, the donor pools are not constructed to yield consistent death benefit payments since the probability of death in the group of donors can vary widely from year to year.

A need therefore exists for a fund-raising method that allows an organization to purchase life insurance policies on a pool of life donors and predictably receive death benefit payments that are credited to the organization. A need also exists for a method of administering a life insurance program for an organization where the organization purchases life insurances policies for a pool of donors, the pool being constructed such that death benefit payments from the policies are predictably paid to the organization, thereby finding any recurring premium payments on the remaining life insurance policies. Finally, a need exists for a method of administering a life insurance program for an organization that allows the organization to purchase life insurance policies on a pool of life donors, wherein each of the life insurance policies builds a cash surrender value from which recurring premium payments can be paid during time periods in which the death benefit payments are not sufficient to pay for the recurring premium payments.

### BRIEF SUMMARY OF THE INVENTION

The problems presented in raising funds for an organization through the purchase of life insurance policies on the organization's donors are solved by the systems and methods of the present invention. In accordance with one embodiment of the present invention, a method of administering a life insurance program for an organization is provided. The first step of the method includes obtaining a list of donors that have consented to participate in the life insurance program. A participant pool is constructed from the list of donors such that it generally conforms to a mortality matrix that describes an “ideal” participant pool. The participant pool includes pool members of selected age and gender such that the number of donors at any particular age and gender are defined by the mortality matrix.

One object of the present invention is to provide a method by which an organization can predictably raise funds through the purchase of life insurance policies on its donors. Another object of the present invention is to provide a method in which a participant pool of donors is selectively constructed based upon donors' ages, genders, and smoking classifications. Another object of the present invention is to provide a method in which donors participating in the life insurance program are not required to undergo medical examinations.

Other objects, features, and advantages of the present invention will become apparent with reference to the drawings and detailed description that follow.

### BRIEF DESCRIPTION OF THE DRAWINGS

FIG. 1 illustrates a flowchart showing a method of raising funds for an organization, wherein the organization participates in a life insurance program in which life insurance policies are purchased on a participant pool of donors.

FIG. 2 depicts a flowchart which demonstrates steps for determining which donors are included in the participant pool.

FIG. 3 illustrates a schematic of a mortality matrix, which is used to construct the participant pool of donors.

FIG. 4 depicts a flowchart showing a method of administering the life insurance program of FIG. 1 according to the present invention.

FIG. 5 illustrate a flowchart showing a computer program product for administering the life insurance program of FIG. 1 according to the present invention.

### DETAILED DESCRIPTION OF THE PREFERRED EMBODIMENT

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

Unless otherwise mentioned, the term “donor” as used throughout this application refers to a person who has contributed an insurable interest in his or her life to an organization. Use of the term “life donor” is also appropriate, however, in most instances only the term “donor” is used. Donors are divided into three classifications, which are more fully described herein: prospective or potential donors, consenting donors, and enrolled donors.

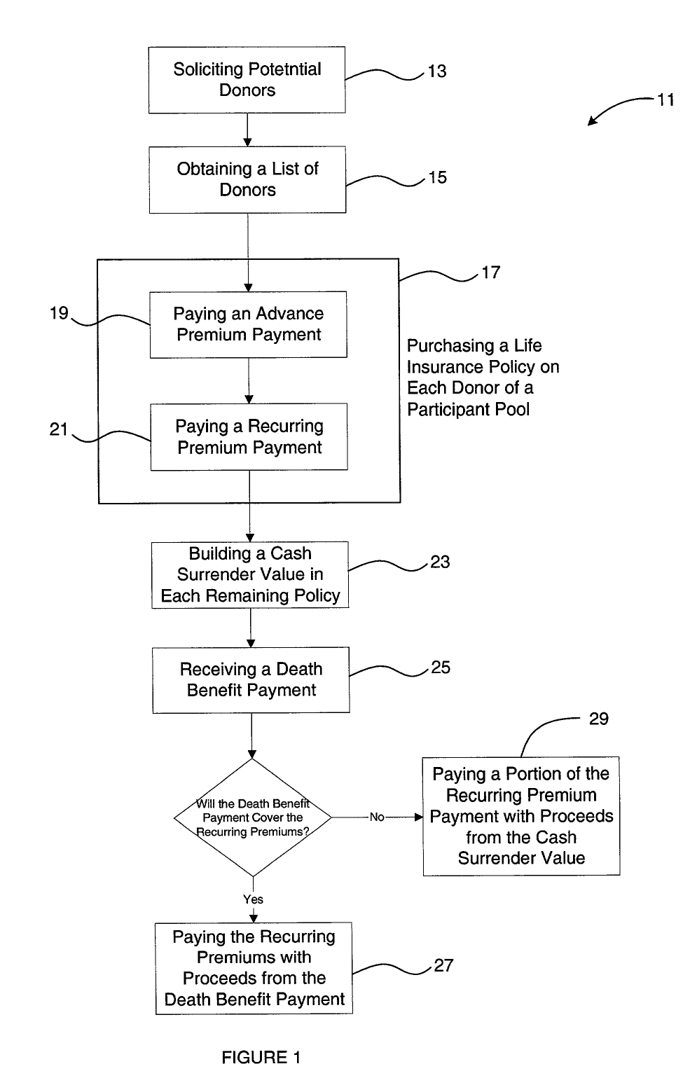

Referring to FIG. 1 in the drawings, a method of fund raising for an organization 11, of for a group of organizations is illustrated. One of the first steps in the fund-raising method 11 is soliciting potential donors 13 for participation in a life insurance program. This step can be performed by the organization seeking to raise funds, or by another entity, such as an administrative entity that assists the organization in its fund-raising efforts. Potential donors could include persons who have previously donated to the organization or persons who have not previously donated. After compiling a list of potential donors, the organization or administrative entity solicits each donor either by mail, telephone, email, or any other means of communications. In some instances, the communication with donors may be “face-to-face” communication that occurs at a program or seminar arranged on behalf of the organization.

During the solicitation phase, potential donors are asked to provide consent for participation in the life insurance program, and consenting donors are asked to provide certain biographical information about themselves. The requested biographical information includes information about the donor's gender, age, and an indication of whether the donor smokes tobacco-related products (referred to herein as a “smoking classification”). A donor's answer to these biographical questions provides valuable information that is used to determine which donors will be allowed to participate in the life insurance program. It is important to note that donors are never asked to undergo a medical exam. This saves the expense of performing medical exams and results in a higher level of consent among solicited donors.

The solicitation of potential donors allows the organization to obtain a list of donors who consent to participation in the life insurance program. The list of consenting donors is examined and analyzed to determine which donors will then be included in the life insurance program. Although this step of analysis and determination could be performed by the organization, it is more likely that the administrative entity or a person or entity familiar with life insurance mortality predictions will conduct this step.

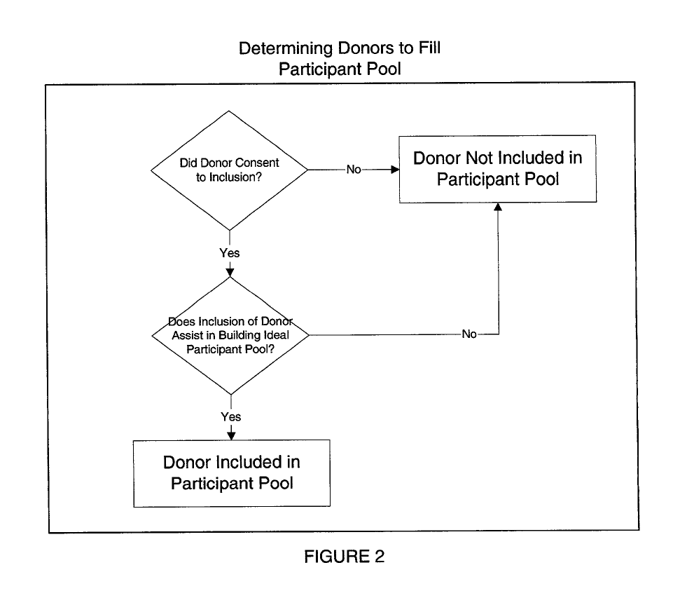

Referring to FIG. 2 in the drawings, the determination of which donors to include in the life insurance program is not an individual qualification process for each donor. Instead, a participant pool (or a matrix-driven mortality pool) of donors is constructed such that the pool contains a selected distribution of donors among various ages, genders, and smoking classifications. In the preferred embodiment, the participant pool will include one thousand donors. Although the participant pool could contain more or fewer donors, as the number of donors in the participant pool decreases, so does the predictability of mortality for any given year or the life of the life of the program.

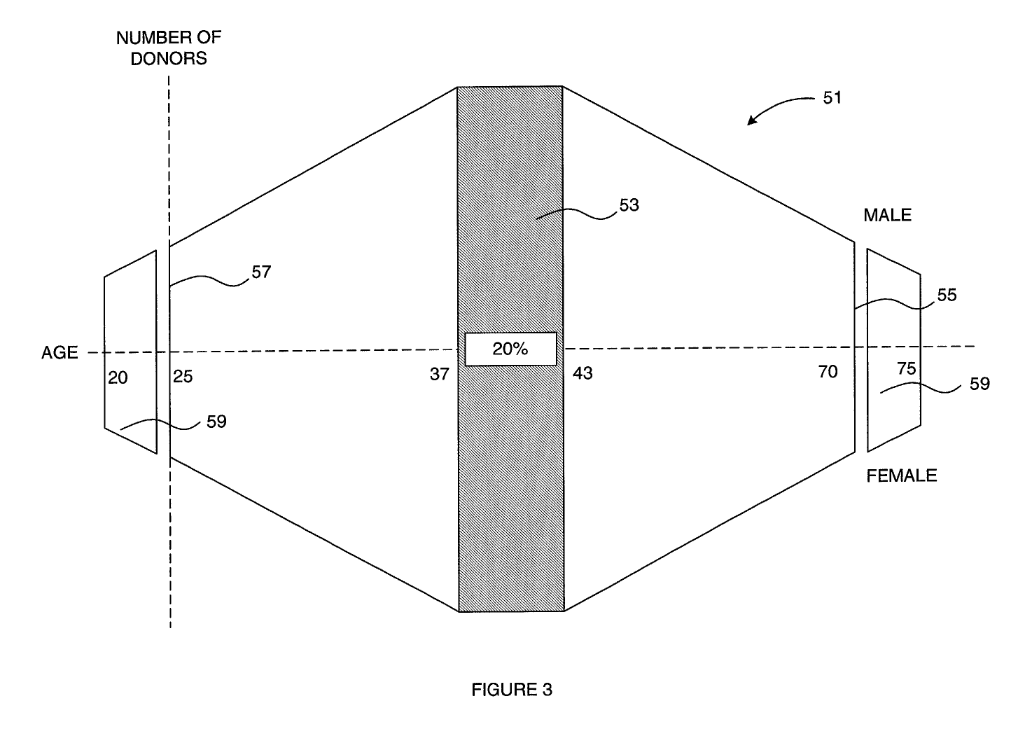

Referring still to FIG. 2, but also to FIG. 3 in the drawings, the process of forming the participant pool is more specifically illustrated. A mortality matrix 51 is constructed that describes an ideal participant pool having pool members of selected ages, genders, and smoking classifications. The mortality matrix is constructed by selecting an average age for the pool members of the ideal participant pool. The ideal participant pool includes a selected percentage of the total number of pool members at an age within a selected deviation 53 of the average age. In a preferred embodiment, the average age of the pool members is forty (40) years and approximately twenty percent (20%) of the pool members are between the ages of thirty-seven (37) and forty-three (43) years. The average age of the mortality matrix 51 could vary depending on the design parameters of the mortality matrix 51, and the percentage of pool members within the selected deviation 53 of the average age could also vary.

Mortality matrix 51 includes an upper age limit 55 and a lower age limit 57 for pool members. Preferably, the upper age limit 55 for pool members is seventy five (75) years and the lower age limit 57 is twenty five (20) years. As demonstrated in FIG. 3, the percentage of pool members at ages outside of the selected deviation 53 generally decreases as the upper age limit 55 is approached. Similarly, the percentage of pool members at ages outside of the selected deviation 53 generally decreases as the lower age limit 57 is approached. The exact percentage of pool members at any particular age outside of the selected deviation depends on the mortality matrix design parameters.

Pool members between the ages of twenty and twenty-five and pool members between the ages of seventy and seventy-five are considered to be life adjusters 59. The role of life adjusters 59 is to allow adjustment of the mortality matrix during construction.

In the preferred embodiment, the mortality matrix includes an age, gender, and smoking classification distribution as illustrated in Table 1. The construction of the mortality matrix is a multiple step, iterative process. The first step is to determine the average age of the list of consenting donors. The list of consenting donors is preferably greater than the participant pool that is being formed. When attempting to form a 1000 donor participant pool, it is best to have at least 1400 consenting donors. After determining the average age of the consenting donors, some donors are omitted from the pool based upon age in order to obtain an average age of approximately 40 years. After adjustment of the pool to obtain the desired average age, some donors having ages within the selected deviation are taken out of the participant pool such that only 20% of the donors in the final participant pool will have ages within the selected deviation. Preferably, the selected deviation is 3 years on either side of the average age. For a pool having an average age of forty, the selected deviation would be between 37 and 43 years. For a pool of 1000 donors, approximately 200 donors in the pool would be between the ages of 37 and 43 years.

After placing donors within the selected deviation, the participant pool is constructed such that approximately 50% of the remaining donors are at ages above the selected deviation (ages 43 to 70) and approximately 50% of the remaining donors are at ages below the selected deviation (ages 25 to 37). Generally, it is preferred that the distribution of these donors is such that the number of donors generally decreases from the selected deviation to either the upper age limit or the lower age limit. However, this could vary slightly among any particular age if adjustments need to be made to maintain the average age of the participant pool.

At each step of the above construction process, the donors forming the participant pool are chosen such that there is a fairly even distribution of male and female genders. Additionally, the percentage of smokers and non-smokers can be adjusted to manipulate the premium price to the organization. Preferably, the mortality matrix allows only 15% of the donors to be smokers. The remaining 85% of the pool members should not smoke tobacco-related products. Finally, life adjusters can also be used to manipulate the premium prices paid by the organization. The addition of life adjusters allows the average age of the participant pool to be easily adjusted.

TABLE 1
Preferred Mortality Matrix

| | Male | Male | Female | Female |
|---|---|---|---|---|
| Age | NS | Smoker | NS | Smoker |
| 25 | 11 | 1 | 11 | 1 |
| 26 | 12 | 1 | 12 | 1 |
| 27 | 13 | 1 | 13 | 1 |
| 28 | 14 | 1 | 14 | 1 |
| 29 | 15 | 1 | 15 | 1 |
| 30 | 16 | 1 | 16 | 1 |
| 31 | 17 | 1 | 17 | 1 |
| 32 | 18 | 1 | 18 | 1 |
| 33 | 19 | 1 | 19 | 1 |
| 34 | 20 | 2 | 20 | 2 |
| 35 | 21 | 2 | 21 | 2 |
| 36 | 22 | 2 | 22 | 2 |
| 37 | 12 | 2 | 12 | 2 |
| 38 | 12 | 2 | 12 | 2 |
| 39 | 12 | 2 | 12 | 2 |
| 40 | 12 | 2 | 12 | 2 |
| 41 | 12 | 2 | 12 | 2 |
| 42 | 12 | 2 | 12 | 2 |
| 43 | 12 | 2 | 12 | 2 |
| 44 | 12 | 1 | 12 | 1 |
| 45 | 12 | 1 | 12 | 1 |
| 46 | 12 | 1 | 12 | 1 |
| 47 | 12 | 1 | 12 | 1 |
| 48 | 12 | 1 | 12 | 1 |
| 49 | 9 | 1 | 9 | 1 |
| 50 | 9 | 1 | 9 | 1 |
| 51 | 9 | 1 | 9 | 1 |
| 52 | 9 | 1 | 9 | 1 |
| 53 | 9 | 1 | 9 | 1 |
| 54 | 7 | 1 | 7 | 1 |
| 55 | 7 | 1 | 7 | 1 |
| 56 | 7 | 1 | 7 | 1 |
| 57 | 7 | 1 | 7 | 1 |
| 58 | 7 | 1 | 7 | 1 |
| 59 | 5 | 1 | 5 | 1 |
| 60 | 4 | 1 | 4 | 1 |
| 61 | 4 | 1 | 4 | 1 |
| 62 | 4 | 1 | 4 | 1 |
| 63 | 4 | 0 | 4 | 0 |
| 64 | 2 | 0 | 2 | 0 |
| 65 | 2 | 0 | 2 | 0 |
| 66 | 1 | 0 | 1 | 0 |
| 67 | 1 | 0 | 1 | 0 |
| 68 | 1 | 0 | 1 | 0 |
| 69 | 1 | 0 | 1 | 0 |
| 70 | 1 | 0 | 1 | 0 |

Table 2 illustrates some of the possible variations allowed for the participant pool. The participant pool formed for the life insurance program is not absolutely required to have 1000 donors. Instead, the pool could have fewer or more donors. The pool illustrated in Table 2 has 910 donors, and the distributions of ages and genders is less structured than that shown in Table 1. Although it would be ideal to form a participant pool having the distribution of Table 1, this is sometimes not practical. It should also be noted that the participant pool represented by Table 2 includes only non-smokers.

TABLE 2
Example of Alternate Mortality Matrix

| Age | Type of Donor | Number |
|---|---|---|
| 25 | Count of Female Non-Smoker | 4 |
| | Count of Female Smoker | 0 |
| | Count of Male Non-smoker | 4 |
| | Count of Male Smoker | 0 |
| 26 | Count of Female Non-Smoker | 7 |
| | Count of Female Smoker | 0 |
| | Count of Male Non-smoker | 4 |
| | Count of Male Smoker | 0 |
| 27 | Count of Female Non-Smoker | 4 |
| | Count of Female Smoker | 0 |
| | Count of Male Non-smoker | 2 |
| | Count of Male Smoker | 0 |
| 28 | Count of Female Non-Smoker | 5 |
| | Count of Female Smoker | 0 |
| | Count of Male Non-smoker | 2 |
| | Count of Male Smoker | 0 |
| 29 | Count of Female Non-Smoker | 2 |
| | Count of Female Smoker | 0 |
| | Count of Male Non-smoker | 1 |
| | Count of Male Smoker | 0 |
| 30 | Count of Female Non-Smoker | 5 |
| | Count of Female Smoker | 0 |
| | Count of Male Non-smoker | 8 |
| | Count of Male Smoker | 0 |
| 31 | Count of Female Non-Smoker | 8 |
| | Count of Female Smoker | 0 |
| | Count of Male Non-smoker | 2 |
| | Count of Male Smoker | 0 |
| 32 | Count of Female Non-Smoker | 9 |
| | Count of Female Smoker | 0 |
| | Count of Male Non-smoker | 4 |
| | Count of Male Smoker | 0 |
| 33 | Count of Female Non-Smoker | 8 |
| | Count of Female Smoker | 0 |
| | Count of Male Non-smoker | 2 |
| | Count of Male Smoker | 0 |
| 34 | Count of Female Non-Smoker | 4 |
| | Count of Female Smoker | 0 |
| | Count of Male Non-smoker | 2 |
| | Count of Male Smoker | 0 |
| 35 | Count of Female Non-Smoker | 8 |
| | Count of Female Smoker | 0 |
| | Count of Male Non-smoker | 4 |
| | Count of Male Smoker | 0 |
| 36 | Count of Female Non-Smoker | 12 |
| | Count of Female Smoker | 0 |
| | Count of Male Non-smoker | 9 |
| | Count of Male Smoker | 0 |
| 37 | Count of Female Non-Smoker | 6 |
| | Count of Female Smoker | 0 |
| | Count of Male Non-smoker | 7 |
| | Count of Male Smoker | 0 |
| 38 | Count of Female Non-Smoker | 9 |
| | Count of Female Smoker | 0 |
| | Count of Male Non-smoker | 15 |
| | Count of Male Smoker | 0 |
| 39 | Count of Female Non-Smoker | 17 |
| | Count of Female Smoker | 0 |
| | Count of Male Non-smoker | 12 |
| | Count of Male Smoker | 0 |
| 40 | Count of Female Non-Smoker | 13 |
| | Count of Female Smoker | 0 |
| | Count of Male Non-smoker | 7 |
| | Count of Male Smoker | 0 |
| 41 | Count of Female Non-Smoker | 10 |
| | Count of Female Smoker | 0 |
| | Count of Male Non-smoker | 10 |
| | Count of Male Smoker | 0 |
| 42 | Count of Female Non-Smoker | 10 |
| | Count of Female Smoker | 0 |
| | Count of Male Non-smoker | 5 |
| | Count of Male Smoker | 0 |
| 43 | Count of Female Non-Smoker | 18 |
| | Count of Female Smoker | 0 |
| | Count of Male Non-smoker | 5 |
| | Count of Male Smoker | 0 |
| 44 | Count of Female Non-Smoker | 10 |
| | Count of Female Smoker | 0 |
| | Count of Male Non-smoker | 5 |
| | Count of Male Smoker | 0 |
| 45 | Count of Female Non-Smoker | 12 |
| | Count of Female Smoker | 0 |
| | Count of Male Non-smoker | 14 |
| | Count of Male Smoker | 0 |
| 46 | Count of Female Non-Smoker | 9 |
| | Count of Female Smoker | 0 |
| | Count of Male Non-smoker | 11 |
| | Count of Male Smoker | 0 |
| 47 | Count of Female Non-Smoker | 9 |
| | Count of Female Smoker | 0 |
| | Count of Male Non-smoker | 9 |
| | Count of Male Smoker | 0 |
| 48 | Count of Female Non-Smoker | 14 |
| | Count of Female Smoker | 0 |
| | Count of Male Non-smoker | 4 |
| | Count of Male Smoker | 0 |
| 49 | Count of Female Non-Smoker | 17 |
| | Count of Female Smoker | 0 |
| | Count of Male Non-smoker | 8 |
| | Count of Male Smoker | 0 |
| 50 | Count of Female Non-Smoker | 13 |
| | Count of Female Smoker | 0 |
| | Count of Male Non-smoker | 5 |
| | Count of Male Smoker | 0 |
| 51 | Count of Female Non-Smoker | 11 |
| | Count of Female Smoker | 0 |
| | Count of Male Non-smoker | 14 |
| | Count of Male Smoker | 0 |
| 52 | Count of Female Non-Smoker | 10 |
| | Count of Female Smoker | 0 |
| | Count of Male Non-smoker | 11 |
| | Count of Male Smoker | 0 |
| 53 | Count of Female Non-Smoker | 18 |
| | Count of Female Smoker | 0 |
| | Count of Male Non-smoker | 11 |
| | Count of Male Smoker | 0 |
| 54 | Count of Female Non-Smoker | 16 |
| | Count of Female Smoker | 0 |
| | Count of Male Non-smoker | 15 |
| | Count of Male Smoker | 0 |
| 55 | Count of Female Non-Smoker | 19 |
| | Count of Female Smoker | 0 |
| | Count of Male Non-smoker | 11 |
| | Count of Male Smoker | 0 |
| 56 | Count of Female Non-Smoker | 10 |
| | Count of Female Smoker | 0 |
| | Count of Male Non-smoker | 19 |
| | Count of Male Smoker | 0 |
| 57 | Count of Female Non-Smoker | 10 |
| | Count of Female Smoker | 0 |
| | Count of Male Non-smoker | 7 |
| | Count of Male Smoker | 0 |
| 58 | Count of Female Non-Smoker | 20 |
| | Count of Female Smoker | 0 |
| | Count of Male Non-smoker | 6 |
| | Count of Male Smoker | 0 |
| 59 | Count of Female Non-Smoker | 17 |
| | Count of Female Smoker | 0 |
| | Count of Male Non-smoker | 9 |
| | Count of Male Smoker | 0 |
| 60 | Count of Female Non-Smoker | 10 |
| | Count of Female Smoker | 0 |
| | Count of Male Non-smoker | 4 |
| | Count of Male Smoker | 0 |
| 61 | Count of Female Non-Smoker | 18 |
| | Count of Female Smoker | 0 |
| | Count of Male Non-smoker | 11 |
| | Count of Male Smoker | 0 |
| 62 | Count of Female Non-Smoker | 13 |
| | Count of Female Smoker | 0 |
| | Count of Male Non-smoker | 6 |
| | Count of Male Smoker | 0 |
| 63 | Count of Female Non-Smoker | 16 |
| | Count of Female Smoker | 0 |
| | Count of Male Non-smoker | 9 |
| | Count of Male Smoker | 0 |
| 64 | Count of Female Non-Smoker | 20 |
| | Count of Female Smoker | 0 |
| | Count of Male Non-smoker | 10 |
| | Count of Male Smoker | 0 |
| 65 | Count of Female Non-Smoker | 15 |
| | Count of Female Smoker | 0 |
| | Count of Male Non-smoker | 13 |
| | Count of Male Smoker | 0 |
| 66 | Count of Female Non-Smoker | 13 |
| | Count of Female Smoker | 0 |
| | Count of Male Non-smoker | 7 |
| | Count of Male Smoker | 0 |
| 67 | Count of Female Non-Smoker | 17 |
| | Count of Female Smoker | 0 |
| | Count of Male Non-smoker | 15 |
| | Count of Male Smoker | 0 |
| 68 | Count of Female Non-Smoker | 20 |
| | Count of Female Smoker | 0 |
| | Count of Male Non-smoker | 8 |
| | Count of Male Smoker | 0 |
| 69 | Count of Female Non-Smoker | 13 |
| | Count of Female Smoker | 0 |
| | Count of Male Non-smoker | 14 |
| | Count of Male Smoker | 0 |
| 70 | Count of Female Non-Smoker | 12 |
| | Count of Female Smoker | 0 |
| | Count of Male Non-smoker | 8 |
| | Count of Male Smoker | 0 |
| | TOTAL COUNT = | 910 |

After structuring mortality matrix 51, the participant pool of donors who will participate in the life insurance program is formed. The participant pool is constructed such that it closely mirrors the mortality matrix 51, and thus the “ideal” participant pool. As mentioned previously, construction of the mortality matrix 51 and the participant pool may be performed by the organization, although it is more likely that another entity will perform this step.

Referring again to FIG. 1, the organization obtains a list of donors 15 that form the participant pool for the life insurance program. The next step in the fund-raising method is purchasing a life insurance policy on the life of each donor 17 in the participant pool. For a participant pool containing one-thousand donors, one-thousand life insurance policies are purchased. In a preferred embodiment, each donor in the participant pool is insured for $125,000 payable to the organization upon the death of that donor. It is certainly conceivable, however, that the dollar value of insurance provided for each donor could be more or less than $125,000.

Several sub-steps can be involved in purchasing life insurance policies 17. In a preferred embodiment, paying an advance premium payment 19 covers all premiums for the life insurance policies in the participant pool for a selected number of years. Preferably, the selected number of years is six years. The organization pays the advance premium payment at the beginning of the life insurance program, and no further premiums are due until the beginning of the seventh year. After the selected number of years (six years in the preferred embodiment), the life insurance program is funded by paying a recurring premium payment 21. The recurring premium payment is paid each year for each remaining policy in the participant pool.

Preferably, the life insurance policy purchased on the life of each donor is a non dividend paying, non participating, flexible premium adjustable universal life insurance policy. This type of policy builds a cash surrender value 23 for each policy as premiums are paid. Since the owner of a universal life policy can typically access the cash surrender value of a policy, proceeds from the cash surrender value may be used to pay future recurring premiums as explained in more detail below. It is also important to note that financial benefit to the organization is enhanced by purchasing an extremely low-load policy for each of the donors. An example of this type of policy is offered by Transamerica Occidental Life Insurance Company at an adjustable load (as low as one percent (1%). While it is preferable to use universal life insurance policies with the fund-raising method of the present invention, it is possible to use other types of policies, including but not limited to term life policies, or Group life policies.

The fund-raising method of the present invention includes the step of receiving a death benefit payment 25 from one of the life insurance policies upon the death of one of the donors in the participant pool. Over the course of the life insurance program, all of the donors will eventually expire. Assuming that 1,000 donors form the participant pool, and assuming that each donor is insured for $125,000, the gross amount of death benefit payments to the organization over the life of the participant pool will be $125 million.

The source of finding for the advance premium payment can largely determine the level of overall benefit obtained by the organization. The most desirable choice is to pay the advance premium payment with proceeds from a donation given to the organization. Alternatively, the organization may choose to pay the advance premium payment with unallocated funds that are currently within the organization's possession. A third method of funding is for the organization to obtain a loan to pay the advance premium payment. Because of the high level of predictability afforded by the life insurance program, financing of the advance premium payment has been approved by banks and organizations such as A.I. Credit Corporation. When the organization receives a loan for the advance premium payment, the principal of the loan can be repaid with proceeds from the death benefit payments received in a given year. Any interest on the loan is preferably paid by a monetary donation to the organization. Alternatively, interest can be paid with proceeds from the death benefit payment or cash surrender values of the policy.

The life insurance program is designed to support itself as soon as the recurring premium payments are required. As mentioned previously, the advance premium payment covers all premiums for the policies in the participant pool for the selected number of years. After the selected number of years, the recurring premium payments (preferably yearly payments) are made for each of the remaining policies in the participant pool. As donors in the participant pool die, the policies associated with these donors provide death benefit payments, which are used for paying the recurring premium payments 27 (see FIG. 1). The participant pool is structured such that the statistically expected death benefit payments for any given year of the life insurance program will exceed the recurring premium payment for that year. Of course, statistical predictions are not always indicative of actual occurrences. In those years that the death benefit payments within the participant pool do not exceed the recurring premium payments, money can be withdrawn from the cash surrender values of the policies for paying a portion of the recurring premium payments 29 (see FIG. 1).

Examples of predicted cash flow amounts under the life insurance program are illustrated in Tables 3 through 6 below. Each table displays the expected recurring premium payments and death benefit payments throughout the life of the program. Also shown are the predicted net amounts to the organization in each year of the program. Several assumptions are made with respect to the cash flows shown in each table, and these assumptions represent the preferred method of implementing the life insurance program. First, it is assumed that the participant pool contains one thousand donors, and that the average age of donors in the pool is forty (40) years. The tables further assume that the death benefit payment for each policy is $125,000, and the advance premium payment is $3 million. This advance premium payment is meant to cover the premiums for all policies in the participant pool for the first six years of the life insurance program. Finally, the tables assume that premium payments are made at the beginning of each year and death benefit payments are paid at the end of each year.

The death benefit payments listed in the tables are not in increments of $125,000. The estimates for the number of donors dying in each year are statistically based and seldom result in a “whole” number of people dying in any given year. For instance, if the expected death benefit payment in a given year is $464,000, then 3.7 donors in the participant pool are statistically expected to die in that year.

Referring more specifically to Table 3, an 80 CSO mortality table predicts the recurring premium payments and death benefit payments over the life of the life insurance program. This mortality table is relatively aggressive and is used by most insurance regulatory organizations, such as the Texas Department of Insurance, to predict mortality. The net proceeds to the organization under this mortality table is over $74 million.

TABLE 3
80 CSO Mortality Schedule

| | Premium | Death Benefit | Net to |
|---|---|---|---|
| Year | Payments | Payments | Organization |
| 1 | (3,000,000) | 281,000 | (2,719,000) |
| 2 | — | 303,000 | 303,000 |
| 3 | — | 325,000 | 325,000 |
| 4 | — | 349,000 | 349,000 |
| 5 | — | 374,000 | 374,000 |
| 6 | — | 401,000 | 401,000 |
| 7 | (270,527) | 432,000 | 161,473 |
| 8 | (269,577) | 464,000 | 194,423 |
| 9 | (341,799) | 498,000 | 156,201 |
| 10 | (340,404) | 536,000 | 195,596 |
| 11 | (411,526) | 577,000 | 165,474 |
| 12 | (409,564) | 624,000 | 214,436 |
| 13 | (527,278) | 678,000 | 150,722 |
| 14 | (524,295) | 739,000 | 214,705 |
| 15 | (615,779) | 806,000 | 190,221 |
| 16 | (611,588) | 880,000 | 268,412 |
| 17 | (700,398) | 960,000 | 259,602 |
| 18 | (694,638) | 1,042,000 | 347,362 |
| 19 | (780,171) | 1,128,000 | 347,829 |
| 20 | (772,500) | 1,224,000 | 451,500 |
| 21 | (1,146,266) | 1,327,000 | 180,734 |
| 22 | (1,132,730) | 1,441,000 | 308,270 |
| 23 | (1,315,332) | 1,571,000 | 255,668 |
| 24 | (1,296,480) | 1,717,000 | 420,520 |
| 25 | (1,488,522) | 1,878,000 | 389,478 |
| 26 | (1,462,230) | 2,048,000 | 585,770 |
| 27 | (1,535,955) | 2,223,000 | 687,045 |
| 28 | (1,502,610) | 2,401,000 | 898,390 |
| 29 | (1,642,586) | 2,578,000 | 935,414 |
| 30 | (1,599,276) | 2,760,000 | 1,160,724 |
| 31 | (1,737,778) | 2,952,000 | 1,214,222 |
| 32 | (1,682,280) | 3,204,000 | 1,521,720 |
| 33 | (1,708,324) | 3,386,000 | 1,677,676 |
| 34 | (1,641,281) | 3,631,000 | 1,989,719 |
| 35 | (1,696,207) | 3,879,000 | 2,182,793 |
| 36 | (1,613,196) | 4,108,000 | 2,494,804 |
| 37 | (1,639,325) | 4,306,000 | 2,666,675 |
| 38 | (1,540,287) | 4,469,000 | 2,928,713 |
| 39 | (1,487,500) | 4,580,000 | 3,092,500 |
| 40 | (1,378,496) | 4,649,000 | 3,270,504 |
| 41 | (1,374,392) | 4,686,000 | 3,311,608 |
| 42 | (1,253,493) | 4,692,000 | 3,438,507 |
| 43 | (1,167,554) | 4,667,000 | 3,499,446 |
| 44 | (1,043,412) | 4,604,000 | 3,560,588 |
| 45 | (920,945) | 4,483,000 | 3,562,055 |
| 46 | (813,753) | 4,293,000 | 3,479,247 |
| 47 | (697,842) | 4,031,000 | 3,333,158 |
| 48 | (593,368) | 3,708,000 | 3,114,632 |
| 49 | (492,510) | 3,336,000 | 2,843,490 |
| 50 | (401,771) | 2,938,000 | 2,536,229 |
| 51 | (321,858) | 2,535,000 | 2,213,142 |
| 52 | (258,484) | 2,142,000 | 1,883,516 |
| 53 | (198,937) | 1,774,000 | 1,575,063 |
| 54 | (149,620) | 1,440,000 | 1,290,380 |
| 55 | (109,588) | 1,152,000 | 1,042,412 |
| 56 | (75,888) | 913,000 | 837,112 |
| 57 | (51,054) | 718,000 | 666,946 |
| 58 | (31,525) | 555,000 | 523,475 |
| 59 | (16,236) | 397,000 | 380,764 |
| 60 | (5,564) | 207,000 | 201,436 |
| 61 | — | — | — |
| Totals | (50,494,500) | 125,000,000 | 74,505,500 |

Referring to Table 4, an 83 GAM mortality table predicts the recurring premium payments and death benefit payments over the life of the life insurance program. This mortality table is less aggressive and is often used by planners to predict pension mortality. The net proceeds to the organization under this mortality table is over $67 million.

TABLE 4
83 GAM Mortality Schedule

| | Premium | Death Benefit | Net to |
|---|---|---|---|
| Year | Payments | Payments | Organization |
| 1 | (3,000,000) | 155,000 | (2,845,000) |
| 2 | — | 171,000 | 171,000 |
| 3 | — | 190,000 | 190,000 |
| 4 | — | 213,000 | 213,000 |
| 5 | — | 240,000 | 240,000 |
| 6 | — | 271,000 | 271,000 |
| 7 | (272,272) | 306,000 | 33,728 |
| 8 | (271,599) | 344,000 | 72,401 |
| 9 | (344,708) | 386,000 | 41,292 |
| 10 | (343,627) | 431,000 | 87,373 |
| 11 | (415,796) | 478,000 | 62,204 |
| 12 | (414,171) | 527,000 | 112,829 |
| 13 | (533,667) | 577,000 | 43,333 |
| 14 | (531,128) | 628,000 | 96,872 |
| 15 | (624,432) | 680,000 | 55,568 |
| 16 | (620,896) | 732,000 | 111,104 |
| 17 | (712,026) | 785,000 | 72,974 |
| 18 | (707,316) | 842,000 | 134,684 |
| 19 | (795,899) | 903,000 | 107,101 |
| 20 | (789,759) | 974,000 | 184,241 |
| 21 | (1,174,703) | 1,055,000 | (119,703) |
| 22 | (1,163,942) | 1,148,000 | (15,942) |
| 23 | (1,355,568) | 1,258,000 | (97,568) |
| 24 | (1,340,472) | 1,384,000 | 43,528 |
| 25 | (1,544,508) | 1,530,000 | (14,508) |
| 26 | (1,523,088) | 1,696,000 | 172,912 |
| 27 | (1,606,440) | 1,883,000 | 276,560 |
| 28 | (1,578,195) | 2,084,000 | 505,805 |
| 29 | (1,732,567) | 2,292,000 | 559,433 |
| 30 | (1,694,062) | 2,502,000 | 807,938 |
| 31 | (1,848,698) | 2,707,000 | 858,302 |
| 32 | (1,797,806) | 2,903,000 | 1,105,194 |
| 33 | (1,835,955) | 3,094,000 | 1,258,045 |
| 34 | (1,774,694) | 3,288,000 | 1,513,306 |
| 35 | (1,847,740) | 3,487,000 | 1,639,260 |
| 36 | (1,773,118) | 3,695,000 | 1,921,882 |
| 37 | (1,820,703) | 3,910,000 | 2,089,297 |
| 38 | (1,730,773) | 4,121,000 | 2,390,227 |
| 39 | (1,692,894) | 4,316,000 | 2,623,106 |
| 40 | (1,590,173) | 4,485,000 | 2,894,827 |
| 41 | (1,608,088) | 4,617,000 | 3,008,912 |
| 42 | (1,488,970) | 4,703,000 | 3,214,030 |
| 43 | (1,410,039) | 4,735,000 | 3,324,961 |
| 44 | (1,284,088) | 4,708,000 | 3,423,912 |
| 45 | (1,158,856) | 4,620,000 | 3,461,144 |
| 46 | (1,051,542) | 4,473,000 | 3,421,458 |
| 47 | (930,771) | 4,281,000 | 3,350,229 |
| 48 | (821,222) | 4,042,000 | 3,220,778 |
| 49 | (711,280) | 3,768,000 | 3,056,720 |
| 50 | (608,790) | 3,466,000 | 2,857,210 |
| 51 | (514,515) | 3,146,000 | 2,631,485 |
| 52 | (438,406) | 2,811,000 | 2,372,594 |
| 53 | (360,260) | 2,469,000 | 2,108,740 |
| 54 | (291,622) | 2,130,000 | 1,838,378 |
| 55 | (232,408) | 1,822,000 | 1,589,592 |
| 56 | (177,834) | 1,531,000 | 1,353,166 |
| 57 | (136,190) | 1,244,000 | 1,107,810 |
| 58 | (102,354) | 994,000 | 891,646 |
| 59 | (74,431) | 778,000 | 703,569 |
| 60 | (53,518) | 596,000 | 542,482 |
| 61 | — | — | — |
| Totals | (56,258,581) | 123,605,000 | 67,346,419 |

Referring to Table 5, a UP84 mortality table predicts the recurring premium payments and death benefit payments over the life of the life insurance program. This mortality table is often used by large insurance companies in product design, and in the present invention, use of the UP84 mortality table (and adjustments thereto) is preferred to predict cash flow during the life of the insurance program. The net proceeds to the organization under this mortality table is over $74 million.

TABLE 5
UP84 Mortality Schedule

| | Premium | Death Benefit | Net to |
|---|---|---|---|
| Year | Payments | Payments | Organization |
| 1 | (3,000,000) | 266,000 | (2,734,000) |
| 2 | — | 290,000 | 290,000 |
| 3 | — | 318,000 | 318,000 |
| 4 | — | 350,000 | 350,000 |
| 5 | — | 383,000 | 383,000 |
| 6 | — | 421,000 | 421,000 |
| 7 | (270,538) | 463,000 | 192,462 |
| 8 | (269,520) | 512,000 | 242,480 |
| 9 | (341,592) | 565,000 | 223,408 |
| 10 | (340,010) | 620,000 | 279,990 |
| 11 | (410,761) | 678,000 | 267,239 |
| 12 | (408,456) | 744,000 | 335,544 |
| 13 | (525,316) | 818,000 | 292,684 |
| 14 | (521,717) | 894,000 | 372,283 |
| 15 | (611,926) | 974,000 | 362,074 |
| 16 | (606,861) | 1,054,000 | 447,139 |
| 17 | (693,900) | 1,142,000 | 448,100 |
| 18 | (687,048) | 1,238,000 | 550,952 |
| 19 | (770,236) | 1,344,000 | 573,764 |
| 20 | (761,097) | 1,450,000 | 688,903 |
| 21 | (1,126,855) | 1,565,000 | 438,145 |
| 22 | (1,110,892) | 1,689,000 | 578,108 |
| 23 | (1,286,664) | 1,824,000 | 537,336 |
| 24 | (1,264,776) | 1,969,000 | 704,224 |
| 25 | (1,448,006) | 2,122,000 | 673,994 |
| 26 | (1,418,298) | 2,286,000 | 867,702 |
| 27 | (1,485,315) | 2,460,000 | 974,685 |
| 28 | (1,448,415) | 2,630,000 | 1,181,585 |
| 29 | (1,578,041) | 2,784,000 | 1,205,959 |
| 30 | (1,531,270) | 2,923,000 | 1,391,730 |
| 31 | (1,658,611) | 3,065,000 | 1,406,389 |
| 32 | (1,600,989) | 3,208,000 | 1,607,011 |
| 33 | (1,622,630) | 3,349,000 | 1,726,370 |
| 34 | (1,556,320) | 3,498,000 | 1,941,680 |
| 35 | (1,607,226) | 3,643,000 | 2,035,774 |
| 36 | (1,529,265) | 3,781,000 | 2,251,735 |
| 37 | (1,556,640) | 3,910,000 | 2,353,360 |
| 38 | (1,466,710) | 4,026,000 | 2,559,290 |
| 39 | (1,421,907) | 4,100,000 | 2,678,093 |
| 40 | (1,324,327) | 4,154,000 | 2,829,673 |
| 41 | (1,328,442) | 4,184,000 | 2,855,558 |
| 42 | (1,220,495) | 4,187,000 | 2,966,505 |
| 43 | (1,146,965) | 4,149,000 | 3,002,035 |
| 44 | (1,036,602) | 4,065,000 | 3,028,398 |
| 45 | (928,473) | 3,938,000 | 3,009,527 |
| 46 | (836,109) | 3,780,000 | 2,943,891 |
| 47 | (734,049) | 3,593,000 | 2,858,951 |
| 48 | (641,757) | 3,378,000 | 2,736,243 |
| 49 | (549,875) | 3,136,000 | 2,586,125 |
| 50 | (464,576) | 2,873,000 | 2,408,424 |
| 51 | (386,430) | 2,592,000 | 2,205,570 |
| 52 | (322,897) | 2,300,000 | 1,977,103 |
| 53 | (258,957) | 2,003,000 | 1,744,043 |
| 54 | (203,274) | 1,703,000 | 1,499,726 |
| 55 | (155,930) | 1,416,000 | 1,260,070 |
| 56 | (114,050) | 1,148,000 | 1,033,950 |
| 57 | (82,824) | 904,000 | 821,176 |
| 58 | (58,235) | 690,000 | 631,765 |
| 59 | (39,003) | 506,000 | 466,997 |
| 60 | (25,402) | 357,000 | 331,598 |
| 61 | — | — | — |
| Totals | (49,796,477) | 124,412,000 | 74,615,523 |

Referring to Table 6, an 85-90 Ultimate mortality table predicts the recurring premium payments and death benefit payments over the life of the life insurance program. This mortality table (and adjustments thereto) is one of the least aggressive and is used by some insurance companies for more contemporary product design. The net proceeds to the organization under this mortality table is over $67 million.

TABLE 6
85-90 Ultimate Mortality Schedule

| | Premium | Death Benefit | Net to |
|---|---|---|---|
| Year | Payments | Payments | Organization |
| 1 | (3,000,000) | 68,750 | (2,931,250) |
| 2 | — | 102,444 | 102,444 |
| 3 | — | 132,319 | 132,319 |
| 4 | — | 159,612 | 159,612 |
| 5 | — | 181,824 | 181,824 |
| 6 | — | 205,186 | 205,186 |
| 7 | (273,130) | 240,851 | (32,279) |
| 8 | (272,600) | 282,513 | 9,913 |
| 9 | (346,154) | 323,901 | (22,253) |
| 10 | (345,247) | 357,578 | 12,330 |
| 11 | (418,013) | 394,654 | (23,360) |
| 12 | (416,671) | 442,407 | 25,736 |
| 13 | (537,275) | 490,874 | (46,401) |
| 14 | (535,115) | 560,655 | 25,540 |
| 15 | (629,493) | 644,020 | 14,527 |
| 16 | (626,145) | 741,740 | 115,596 |
| 17 | (718,024) | 847,268 | 129,244 |
| 18 | (712,940) | 937,517 | 224,576 |
| 19 | (801,624) | 1,020,892 | 219,268 |
| 20 | (794,682) | 1,105,543 | 310,861 |
| 21 | (1,180,746) | 1,199,268 | 18,522 |
| 22 | (1,168,514) | 1,301,404 | 132,890 |
| 23 | (1,359,105) | 1,390,818 | 31,712 |
| 24 | (1,342,416) | 1,486,725 | 144,310 |
| 25 | (1,545,337) | 1,621,500 | 76,163 |
| 26 | (1,522,636) | 1,872,843 | 350,206 |
| 27 | (1,603,303) | 2,000,923 | 397,619 |
| 28 | (1,573,290) | 2,106,110 | 532,821 |
| 29 | (1,726,702) | 2,244,712 | 518,011 |
| 30 | (1,688,991) | 2,419,881 | 730,891 |
| 31 | (1,844,567) | 2,643,225 | 798,658 |
| 32 | (1,794,874) | 2,855,569 | 1,060,694 |
| 33 | (1,833,806) | 3,044,304 | 1,210,497 |
| 34 | (1,773,529) | 3,225,494 | 1,451,965 |
| 35 | (1,847,819) | 3,415,011 | 1,567,192 |
| 36 | (1,774,738) | 3,617,479 | 1,842,742 |
| 37 | (1,824,226) | 3,807,874 | 1,983,648 |
| 38 | (1,736,645) | 3,941,430 | 2,204,784 |
| 39 | (1,703,244) | 4,117,128 | 2,413,884 |
| 40 | (1,605,257) | 4,262,024 | 2,656,767 |
| 41 | (1,630,192) | 4,401,518 | 2,771,326 |
| 42 | (1,516,633) | 4,516,391 | 2,999,758 |
| 43 | (1,443,524) | 4,532,449 | 3,088,925 |
| 44 | (1,322,961) | 4,555,760 | 3,232,799 |
| 45 | (1,201,778) | 4,516,154 | 3,314,377 |
| 46 | (1,097,913) | 4,426,218 | 3,328,304 |
| 47 | (978,406) | 4,260,050 | 3,281,645 |
| 48 | (869,780) | 4,050,551 | 3,180,771 |
| 49 | (759,605) | 3,802,771 | 3,043,166 |
| 50 | (656,169) | 3,523,050 | 2,866,881 |
| 51 | (560,342) | 3,219,084 | 2,658,742 |
| 52 | (483,212) | 2,906,226 | 2,423,014 |
| 53 | (402,419) | 2,589,814 | 2,187,394 |
| 54 | (330,422) | 2,275,279 | 1,944,857 |
| 55 | (267,170) | 1,968,502 | 1,701,332 |
| 56 | (207,860) | 1,678,776 | 1,470,916 |
| 57 | (162,197) | 1,408,255 | 1,246,058 |
| 58 | (123,893) | 1,159,036 | 1,035,143 |
| 59 | (91,280) | 1,697,924 | 1,606,644 |
| 60 | (45,640) | 1,697,924 | 1,652,284 |
| 61 | — | — | — |
| Totals | (57,028,257) | 125,000,000 | 67,971,743 |

By structuring the ideal participant pool such that generally more pool members are included having ages near the average age of the pool, and by causing the profile of the ideal participant pool to follow the mortality matrix, the predictability of death within the participant pool in any given year is increased. Since the predictability of death is relatively high, it is easy to predict the amount of death benefit payments that will be received and the amount of recurring premium payments that will need to be payed in any given year.

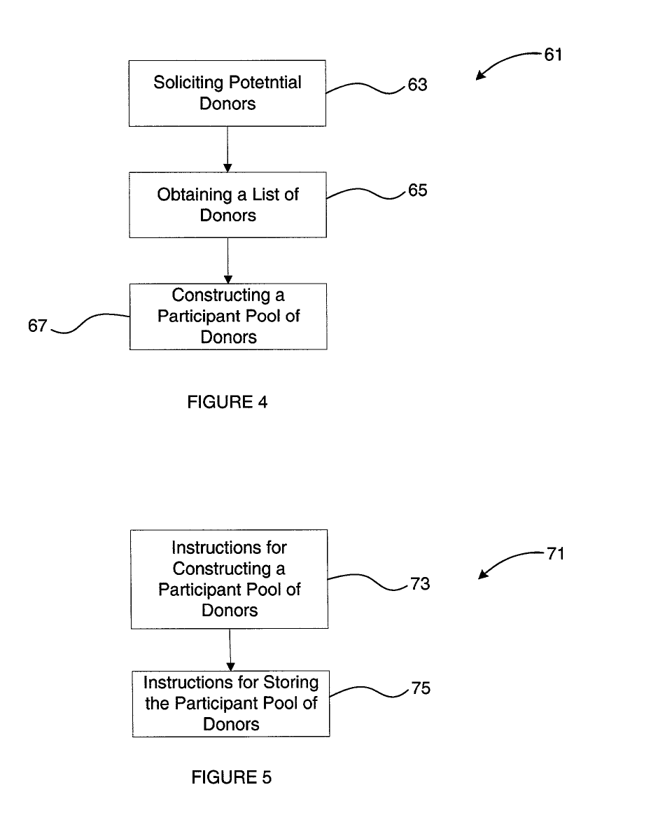

Referring to FIG. 4 in the drawings, a method of administering the life insurance program 61 of the present invention is illustrated. As previously mentioned, an administrative entity, such as an insurance agent, insurance company, or financial institution, could administer the life insurance program on behalf of the organization. However, a person of ordinary skill in the art will appreciate that the administrative duties could all be performed by the organization.

One of the first administrative steps is to solicit potential donors 63 as previously described. After consenting donors have responded to the solicitation, a list of consenting donors is obtained 65 by the entity that administers the life insurance program. The list of consenting donors includes those who indicated a desire to participate in the life insurance program.

Not all of the donors from the list of consenting donors will be included in the life insurance program. Instead, a participant pool of donors is constructed 67 as previously described. The participant pool is constructed such that it conforms to a mortality matrix similar to the mortality matrix 51 shown in FIG. 3. Conformance to the mortality matrix does not mean that the participant pool needs to be identical to the mortality matrix, or the ideal participant pool. Instead, the actual participant pool should be constructed from the list of consenting donors and should approximate the age, gender, and smoking classification distributions as closely as possible. One having skill in the art will recognize that the mortality matrix, and thus the actual participant pool could be constructed based solely upon age, without reference to gender or smoking classification. This construction would still yield predictable cash flows for the organization, however, the use of gender and smoking classification increases the predictability of mortality in the participant pool.

Other steps may also be taken by the administrative entity. The entity could issue the insurance policies that will be purchased for donors in the participant pool. If this step is performed, the administrative entity will likely be an insurance or reinsurance company. Additionally, the administrative entity may assist the organization with respect to the payment and receipt of money related to the life insurance program. This could be accomplished by assisting the organization in paying a premium payment (either the recurring premium payment or the advance premium payment) for a life insurance policy on a donor in the participant pool, or assisting the organization in receiving a death benefit payment from one of the insurance policies utilizing a Social Security “sweep” process. If the administrative entity takes an active role throughout the life of the program, the entity may actually receive death benefit payments and pay premium payments on behalf of the organization. Finally, another important step performed by the administrative entity is to assist the organization in obtaining financing for the life insurance program. Although not all organizations will use financing, the ability to finance some portion or all of the premium payments will be essential to some organizations. The administrative entity will play a role in directing the organization to the unique financing plans used with the life insurance program.

Referring now to FIG. 5 in the drawings, a computer program product 71 according to the present invention is illustrated. Computer program product 71 implements the method of the present invention. Computer program product 71 includes instructions for constructing a participant pool of donors desiring to participate in the life insurance program 73 and instructions for storing the participant pool of donors 75. The construction of the participant pool is accomplished as previously described so that the participant pool closely resembles the mortality matrix. After inputting information on the mortality matrix and the list of consenting donors into the computer program product 71, the program product 71 automatically constructs a participant pool from the list of consenting donors to closely approximate the mortality matrix.

The primary advantage of the present invention is that it provides a method by which an organization can predictably raise funds through the purchase of life insurance on the organization's donors. By purchasing life insurance policies on a participant pool of donors that has been structured to match a mortality matrix, the organization can obtain predictable results regarding the cash flow of premiums and death benefit payments during the life of the life insurance program. Another advantage of the present invention is that it provides a system and method for administering the life insurance program that can be performed by either the organization or an administrative entity. The administration method provides for the construction of the participant pool based on donors' ages, genders, and smoking classifications as represented in the mortality matrix. Another advantage of the present is that donors participating in the life insurance program are not required to undergo medical screening examinations. This significantly increases the level of donor participation in the program since many donors would consider medical examinations too personally invasive or time intensive.

The present invention will primarily be used by non-profit organizations such as charities, churches, schools, hospitals, and other foundations. However, one skilled in the art of the invention will see that the methods embodied herein could be used by any person, organization, or other entity that is allowed to hold an insurable interest on the lives of donors making up a participant pool. One skilled in the art of the invention will also recognize that many different ways exist to purchase the life insurance policies. As previously described, the organization preferably pays an advance premium payment followed by a series of recurring premium payments. However, single premiums, level premiums, or recurring premium payments could be used solely in lieu of any advance premium payment. The frequency of payments and amount of premiums under the life insurance program could also vary depending upon the construction of the participant pool and the insurance product available to the participant pool.

A person having ordinary skill in the art will also recognize that the mortality matrix may be constructed based solely on age, without regard to gender or smoking classification. However, the preferred method, which also yields the highest level of predictability, is to structure the mortality matrix based not only upon the ages of the pool members, but also upon gender and smoking classification.

It should be apparent from the foregoing that an invention having significant advantages has been provided. While the invention is shown in only a few of its forms, it is not just limited but is susceptible to various changes and modifications without departing from the spirit thereof.

We claim:

1. A method of designing a life insurance program for an organization comprising the steps of:
obtaining a list of consenting donors who have consented to participate in the life insurance program; and
constructing a matrix-driven mortality pool of enrolled donors, wherein the enrolled donors are selected to form the mortality pool based on the donors' ages.

2. The method according to claim 1, wherein the enrolled donors are selected to form the mortality pool based not only on age, but also on gender.

3. The method according to claim 1, wherein the enrolled donors are selected to form the mortality pool based not only on age, but also on gender and smoking classification.

4. The method according to claim 1, wherein:
the mortality matrix describes an ideal participant pool having pool members of selected age and gender;
the mortality matrix is constructed by selecting an average age for the pool members and selecting pool members such that a selected percentage of the total number of pool members are of an age within a selected deviation of the average age;
the mortality matrix includes an upper age limit and a lower age limit for pool members;
the percentage of pool members at the upper age limit is less than the selected percentage of the pool members within the selected deviation of the average age; and
the percentage of pool members at the lower age limit is less than the selected percentage of the pool members within the selected deviation of the average age.

5. The method according to claim 1, wherein approximately twenty percent of the enrolled donors are between the ages of 37 and 43 years.

6. The method according to claim 1, wherein the enrolled donors range in age from 20 to 75 years.

7. The method according to claim 1, wherein the mortality pool is constructed without considering the medical condition of any of the enrolled donors.

8. The method according to claim 1 further comprising the step of soliciting potential donors for participation in the life insurance program.

9. The method according to claim 1 further comprising the step of issuing a life insurance policy to cover each enrolled donor in the mortality pool.

10. The method according to claim 9, wherein the life insurance policy is a non dividend paying, non participating, flexible premium adjustable universal life insurance policy.

11. The method according to claim 1 further comprising the steps of:
assisting the organization in paying a premium payment for a life insurance policy on at least one donor in the mortality pool; and
assisting the organization in receiving a death benefit payment from a life insurance policy on at least one donor in the mortality pool.

12. The method according to claim 1 further comprising the steps of:
receiving a death benefit payment on behalf of the organization from a life insurance policy on at least one donor in the mortality pool; and
paying a recurring premium payment on behalf of the organization for a life insurance policy on at least one donor in the mortality pool.

13. The method according to claim 1 further comprising the step of assisting the organization in obtaining financing for a portion of the cost of the life insurance program.

14. The method according to claim 1, wherein the mortality pool includes at least one thousand enrolled donors.

15. A method of administering a life insurance program for an organization comprising the steps of:
obtaining a list of donors who have consented to participate in the life insurance program;
forming a mortality matrix that describes an ideal participant pool having pool members of selected age; and
constructing an actual participant pool of donors from the list of donors that conforms to the mortality matrix.

16. The method according to claim 15, wherein the mortality matrix is formed based not only on age, but also on gender.

17. The method according to claim 15 further comprising:
receiving a death benefit payment on behalf of the organization from a life insurance policy on at least one donor in the participant pool; and
paying a recurring premium payment on behalf of the organization for a life insurance policy on at least one donor in the participant pool.

18. The method according to claim 15 further comprising the steps of:
assisting the organization in paying a premium payment for a life insurance policy on at least one donor in the participant pool; and
assisting the organization in receiving a death benefit payment from a life insurance policy on at least one donor in the participant pool.

19. The method according to claim 15, wherein:
the mortality matrix is constructed by selecting an average age for the pool members and selecting pool members such that a selected percentage of the total number of pool members are of an age within a selected deviation of the average age;
the mortality matrix includes an upper age limit and a lower age limit for pool members;
the percentage of pool members at the upper age limit is less than the selected percentage of the pool members within the selected deviation of the average age; and
the percentage of pool members at the lower age limit is less than the selected percentage of the pool members within the selected deviation of the average age.

20. The method according to claim 15, wherein approximately twenty percent of the pool members are between the ages of 37 and 43 years.

21. The method according to claim 15, wherein the pool members range in age from 25 to 75 years.

22. The method according to claim 15, wherein the mortality matrix is constructed without considering the medical condition of any of the donors.

23. The method according to claim 15 further comprising the step of soliciting potential donors for participation in the life insurance program.

24. The method according to claim 15 further comprising the step of writing a life insurance policy to cover at least one donor in the actual participant pool.

25. The method according to claim 24, wherein the life insurance policy is a universal life insurance policy.

26. The method according to claim 15 further comprising the step of assisting the organization in obtaining financing for a portion of the cost of the life insurance program.

27. The method according to claim 15, wherein the actual participant pool includes at least one thousand donors.

28. A computer program product in a computer readable medium comprising:
instructions for constructing a matrix-driven mortality pool of enrolled donors desiring to participate in a life insurance program;
instructions for storing the mortality pool of donors; and
wherein the enrolled donors are selected to form the mortality pool based on the donors' ages.

29. The computer program product according to claim 28 further comprising instructions for receiving a list of consenting donors who have consented to participate in a life insurance program.

30. The computer program product according to claim 28 further comprising:
instructions for forming the mortality pool, wherein the mortality pool describes an ideal participant pool having pool members of selected age and gender;
wherein the mortality pool is constructed by selecting an average age for the pool members and selecting pool members such that a selected percentage of the total number of pool members are of an age within a selected deviation of the average age;
wherein the mortality pool includes an upper age limit and a lower age limit for pool members;
wherein the percentage of pool members at the upper age limit is less than the selected percentage of the pool members within the selected deviation of the average age; and
wherein the percentage of pool members at the lower age limit is less than the selected percentage of the pool members within the selected deviation of the average age.

31. The computer program product according to claim 30, wherein approximately twenty percent of the pool members are between the ages of 37 and 43 years.

32. The computer program product according to claim 30, wherein the pool members range in age from 20 to 75 years.

33. The computer program product according to claim 28, wherein the mortality pool is constructed without considering the medical condition of any of the donors.

34. The computer program product according to claim 28 further comprising instructions for administering the life insurance program for the organization.
